(19) United States
(12) Patent Application Publication
(10) Pub. No.: US 2015/0101354 A1
(43) Pub. Date: Apr. 16, 2015

(54) AIR CONDITIONING SYSTEM AND METHOD FOR HIGH-VOLTAGE BATTERY OF VEHICLE

(71) Applicant: Hyundai Motor Company, Seoul (KR)

(72) Inventors: Man Ju OH, Yongin-si (KR); Jae Woong KIM, Hwaseong-si (KR); Jae Woo PARK, Ansan-si (KR); Jae Hoon KIM, Cheonan-si (KR)

(73) Assignee: Hyundai Motor Company, Seoul (KR)

(21) Appl. No.: 14/104,943

(22) Filed: Dec. 12, 2013

(30) Foreign Application Priority Data
Oct. 10, 2013 (KR) 10-2013-0120891

(51) Int. Cl. H01M 10/6572; H01M 10/625; H01M 10/613; F25B 21/02; B60H 1/00

(52) U.S. Cl. CPC H01M 10/5085; F25B 21/02; B60H 1/00478; H01M 10/5004; H01M 10/5016; F25B 2321/021
USPC 62/3.2

(57) ABSTRACT

Air conditioning system and method for a high-voltage battery of a vehicle includes a first heat exchanger provided in a battery housing, and a first blower for supplying air to the first heat exchanger. A second heat exchanger is provided in an air extractor of a trunk room, and a second blower supplies air to the second heat exchanger, thereby discharging air inside the trunk room to the outside after performing heat exchange. A peltier element is combined with the second heat exchanger such that a first surface thereof is in contact with the second heat exchanger. A cooling line arranged in such a way that a first end is in contact with a second surface of the peltier element, and a second end thereof exchanges heat between the second end and the first heat exchanger.

### CROSS-REFERENCE TO RELATED APPLICATION

This application claims the benefit of priority to Korean Patent Application No. 10-2013-0120891 filed in the Korean Intellectual Property Office on Oct. 10, 2013, the entire contents of which are incorporated herein by reference.

### TECHNICAL FIELD

The present disclosure relates to an air conditioning system and method for a high-voltage battery of a vehicle, which can efficiently increase or reduce a temperature of a high-voltage battery of an electric vehicle or a hybrid vehicle, thereby maintaining an operational state of the high-voltage battery in an optimal state.

### BACKGROUND

A motor and/or a high-voltage battery are used to drive environment-friendly vehicles, such as an electric vehicle, a hybrid vehicle, and a fuel cell vehicle. However, the conventional high-voltage battery may overheat when electrically charging the battery. Further, the battery may become too cold in winter. Accordingly, the battery may not provide the original performance and may be easily deteriorated. Thus, a technique is required to efficiently air-condition the high-voltage battery.

In the related art, one of air-conditioning techniques for high-voltage batteries of vehicles uses conventional coolant air conditioning systems for cooling the batteries. The high-voltage battery is cooled using convection currents of cold air of a passenger compartment, which is forcibly drawn to the battery.

However, the above mentioned technique undesirably increases the passenger compartment cooling load. Furthermore, when the passenger compartment is cooled, the technique may not cool the battery.

In the related art, a battery cooling/heating system designed to cool and heat a high-voltage battery using a peltier element (thermoelectric element) was proposed. A peltier heat exchanger is mounted to a surface of the high-voltage battery, and fins are provided on an outer surface of the battery so as to dissipate heat from the battery to the atmosphere. However, the battery cooling/heating system according to the related art dissipates waste heat of the battery to the atmosphere. The system further has structural defects because it may undesirably reduce the heat dissipating performance of the battery cooling/heating system.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art. The present disclosure provides an air conditioning system and method for a high-voltage battery of a vehicle, which can efficiently dissipate heat of a peltier element without using hot/cold air of a passenger compartment, thus efficiently air-conditioning the high-voltage battery.

According to an exemplary embodiment of the present disclosure, an air conditioning system for a high-voltage battery of a vehicle includes a first heat exchanger provided in a battery housing, and a first blower for supplying air to the first heat exchanger at a position adjacent to the first heat exchanger. A second heat exchanger is provided in an air extractor of a trunk room, and a second blower supplies air to the second heat exchanger at a position adjacent to the second heat exchanger, thereby discharging air inside the trunk room to an outside after exchanging heat between the air inside the trunk room and the second heat exchanger. A peltier element is combined with the second heat exchanger in such a way that a first surface of the peltier element is in contact with the second heat exchanger. A cooling line, through which a coolant circulates, is arranged in such a way that a first end thereof is in contact with a second surface of the peltier element, and a second end thereof exchanges heat between the second end and the first heat exchanger.

The battery housing may have a sealed structure, and the first heat exchanger and the first blower are disposed inside the battery housing so as to control air inside the battery housing. The second end of the cooling line is inserted into the battery housing and combined with the first heat exchanger inside the battery housing.

The second heat exchanger may be disposed inside the trunk room adjacent to the air extractor, and the second blower may be disposed at a back side of the second heat exchanger and blows the air inside the trunk room to the second heat exchanger.

The cooling line may have a hydraulic pump so as to circulate the coolant through the cooling line.

The battery housing may be installed in a front part inside the trunk room, and the air extractor may be installed in a side part of the trunk room.

Each of the first heat exchanger and the second heat exchanger may be provided with a plurality of heat dissipating fins, so as to exchange heat between the fins and air.

The air conditioning system may further include a controller for controlling an operation of the first blower, the second blower, the peltier element, and the cooling line.

When the high-voltage battery needs to be cooled using a low stage cooling mode, the controller may operate the cooling line and the first blower.

When the high-voltage battery needs to be cooled using a high stage cooling mode, the controller may operate the first blower, the second blower, the peltier element, and the cooling line.

When the high-voltage battery needs to be heated, the peltier element may emit heat from the first surface of the peltier element, and the cooling line and the first blower may be operated.

According to another exemplary embodiment of the present disclosure, an air conditioning method for a high-voltage battery of a vehicle using the air conditioning system includes selecting an operational mode required by the high-voltage battery. A high stage cooling operation is performed when a high stage cooling mode has been selected, in which both the first blower and the second blower are activated, the peltier element cools the first surface of the peltier element, and the coolant is circulated through the cooling line.

The air conditioning method may further include performing a low stage cooling operation, in which the coolant is circulated through the cooling line, the first blower is activated, and a low stage cooling mode has been selected in the selecting the operational mode.

The air conditioning method may further include performing a heating operation, in which the peltier element emits heat from the first surface of the peltier element, the first blower and the cooling line are activated, and a heating mode has been selected in the selecting the operational mode.

In the air conditioning system and method for the high-voltage battery of the vehicle according to the present disclosure, heat of the peltier element efficiently dissipates without using hot/cold air from a passenger compartment, thus efficiently air conditioning the high-voltage battery.

The present disclosure directly dissipates waste heat of the peltier element to the outside using a temperature difference between trunk room air and outside air, thus improving operational performance of the air conditioning system for the high-voltage battery.

Further, in the present disclosure, an outside radiator is installed adjacent to a conventional air extract hole that discharges passenger compartment air. Heat is exchanged by naturally circulated air during a normal driving mode of the vehicle, thereby using minimum energy.

In addition, the present disclosure does not use cold passenger compartment air, thereby reducing the cooling load of an air conditioner of the vehicle which controls the passenger compartment air.

### BRIEF DESCRIPTION OF THE DRAWINGS

The above and other objects, features and other advantages of the present disclosure will be more clearly understood from the following detailed description when taken in conjunction with the accompanying drawings.

FIG. 1 is a view illustrating an air conditioning system for a high-voltage battery of a vehicle according to an embodiment of the present disclosure

FIGS. 2 to 4 are views illustrating an operation of an air conditioning system for a high-voltage battery of a vehicle according to an embodiment of the present disclosure.

### DETAILED DESCRIPTION

Hereinbelow, exemplary embodiments of an air conditioning system and method for a high-voltage battery of a vehicle according to the present disclosure will be described in detail with reference to the accompanying drawings.

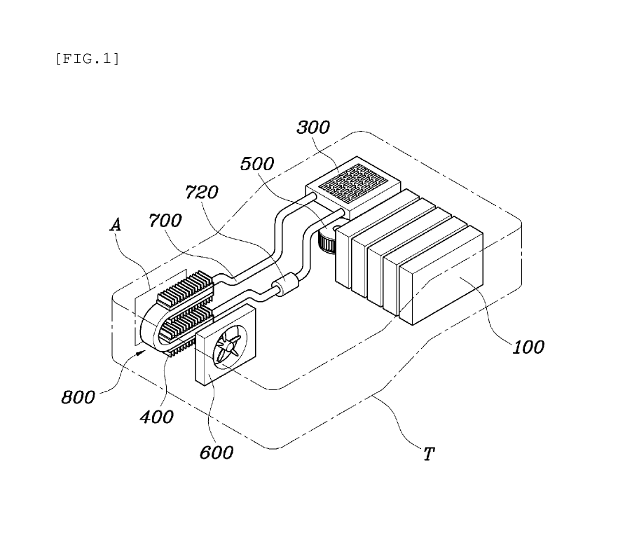

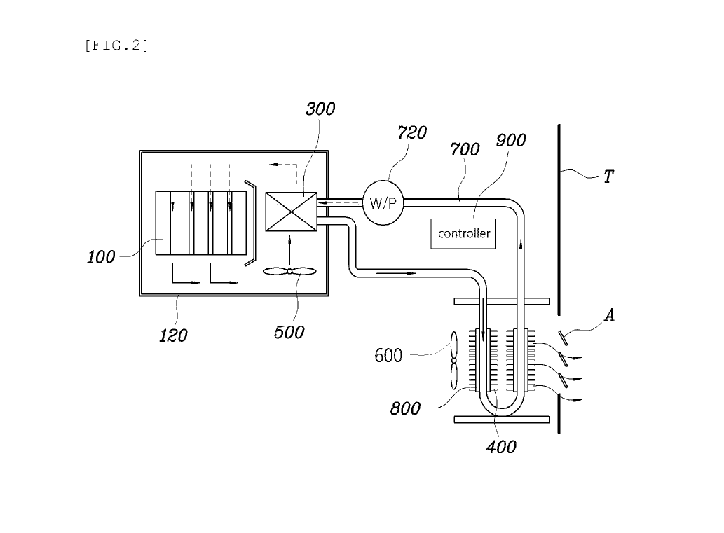

FIG. 1 is a view illustrating an air conditioning system for a high-voltage battery of a vehicle according to an embodiment of the present disclosure. FIGS. 2 to 4 are views illustrating an operation of an air conditioning system for a high-voltage battery of a vehicle according to an embodiment of the present disclosure.

As shown in FIGS. 1 and 2, an air conditioning system for a high-voltage battery of a vehicle according to the present disclosure includes a first heat exchanger 300 provided in a battery housing 120, and a first blower 500 for supplying air to the first heat exchanger 300 at a position adjacent to the first heat exchanger 300. A second heat exchanger 400 is provided in an air extractor A of a trunk room T, and a second blower 600 supplies air to the second heat exchanger 400 at a position adjacent to the second heat exchanger 400, thereby discharging air inside the trunk room T to the outside after exchanging heat between the air inside the trunk room T and the second heat exchanger 400. A peltier element 800 is combined with the second heat exchanger 400 in such a way that a first surface of the peltier element 800 is in contact with the second heat exchanger 400. A cooling line 700, through which a coolant circulates is arranged in such a way that a first end thereof comes into contact with a second surface of the peltier element 800, and a second end thereof exchanges heat between the second end thereof and the first heat exchanger 300.

The system and method of the present disclosure air-condition a high-voltage battery of an environment-friendly vehicle and the housing 120 in which the high-voltage battery 100 is installed.

In the battery housing 120, the first heat exchanger 300 and the first blower 500 that supplies the air to the first heat exchanger 300 are provided. The first blower 500 circulates air inside the housing 120 and heat is exchanged between the air and the first heat exchanger 300, thereby conditioning the air.

An air extractor A may be provided on a side surface of the trunk room T in a vehicle so as to discharge air from the vehicle to the atmosphere. The air extractor A includes an air extract hole toward the outside, and a grill that is combined with the air extract hole. Thus, air inside the vehicle is exhausted to the trunk room, and then discharged from the trunk room to the atmosphere through the air extractor.

In the air extractor A, the second heat exchanger 400 and the second blower 600 are provided. The second blower 600 supplies pressurized air to the second heat exchanger 400 to discharge the air inside the trunk room T to the outside after exchanging heat between the air inside the trunk room and the second heat exchanger 400.

Here, the peltier element 800 is a thermoelectric element. When the first surface of the peltier element is cooled in response to electricity applied thereto, a second surface is heated. When the first surface is heated by the electricity, the second surface is cooled. The peltier element 800 is arranged in the housing 120 such that the first surface is in contact with the first heat exchanger 300.

In addition, the cooling line 700, through which a coolant circulates, is arranged such that the first end thereof is in contact with the second surface of the peltier element 800, and the second end thereof is combined with the first heat exchanger 300 so as to exchange heat between the second end and the first heat exchanger 300. Thus, the present disclosure dissipates the heat of the peltier element 800 by the second heat exchanger 400 using an air-cooling technique and dissipates waste heat of the second heat exchanger 400 functioning as a radiator to the outside through the air extractor A. Accordingly, the heat of the peltier element can be efficiently dissipated to the outside using a temperature difference between trunk room air and outside air, thus improving the cooling efficiency of the peltier element.

As described above, the present disclosure can efficiently dissipate heat of the peltier element, which is an independent element, without using hot/cold air of a passenger compartment. Therefore, the present disclosure can efficiently air-condition the high-voltage battery. Further, because the present disclosure does not use cold passenger compartment air, the disclosure can reduce the cooling load of the air conditioner of the vehicle, which controls the passenger compartment air.

In addition, the present disclosure directly dissipates waste heat of the peltier element to the outside using the air-cooling technique at a location next to the air extractor, thus improving the operational performance of the air conditioning system.

In the present disclosure, the battery housing 120 has a sealed structure, and the first heat exchanger 300 and the first blower 500 are disposed inside the housing 120 so as to control the air inside the housing 120. Further, the second end of the cooling line 700 is inserted into the housing 120 so as to combine with the first heat exchanger 300 inside the housing 120. Due to the sealed structure of the housing 120, the present disclosure may use minimal electricity and can realize maximum operational effect for air-conditioning the battery.

The second heat exchanger 400 may be disposed inside the trunk room T adjacent to the air extractor A, and the second blower 600 may be disposed at a back side of the second heat exchanger 400 so as to blow the air inside the trunk room T to the second heat exchanger 400. In addition, the cooling line 700 may have a hydraulic pump 720 so as to circulate a coolant through the cooling line 700. Here, the peltier element 800 is in contact with the cooling line 700, thereby directly cooling the coolant.

The battery housing 120 may be installed in a front part inside the trunk room T, and the air extractor A may be installed in a side part of the trunk room T. Due to this arrangement, the present disclosure can efficiently use the air inside the trunk room T and can improve the operational performance of the second heat exchanger 400 functioning as a radiator. Here, each of the first heat exchanger 300 and the second heat exchanger 400 is provided with a plurality of heat dissipating fins, thus exchanging the heat between the fins and blown air.

The air conditioning system for the high-voltage battery of the vehicle according to the present disclosure may further include a controller 900 to control the operation of the first blower 500, the second blower 600, the peltier element 800, and the cooling line 700.

The high-voltage battery 100 may need to be slightly cooled, strongly cooled, or heated according to a state of the battery. Referring to FIG. 2, when it is necessary to slightly cool the battery 100 using a low stage cooling mode, the controller 900 may activate both the first blower 500 and the cooling line 700.

In other words, the controller 900 may operate the first blower 500 while circulating the coolant so as to naturally exchange the heat. The low stage cooling mode is used during a normal driving mode of the vehicle which is most frequently used by a driver. During the low stage cooling mode, the peltier element 800 may not operate, so that the present disclosure can efficiently reduce energy consumption. Described in detail, in the present disclosure, the second heat exchanger 400 is installed at a location next to the air extractor A, so heat exchange of the high-voltage battery may be performed using naturally circulated air during the normal driving mode of the vehicle, thereby efficiently saving energy.

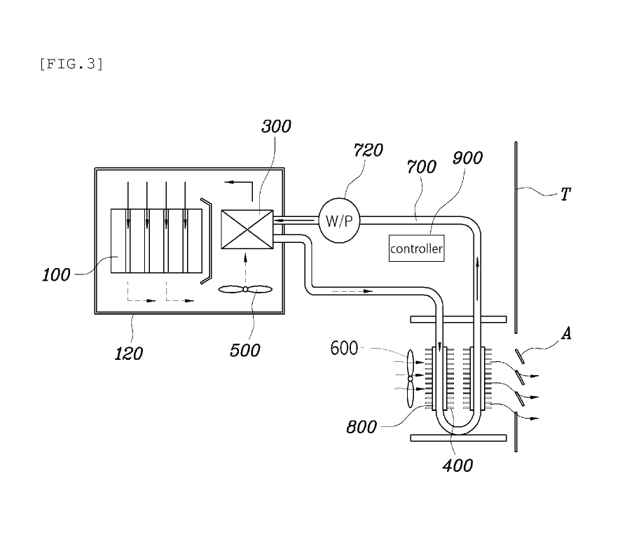

Referring to FIG. 3, when it is necessary to strongly cool the high-voltage battery 100 using a high stage cooling mode, the controller 900 may operate all of the first blower 500, the second blower 600, the peltier element 800, and the cooling line 700. In the high stage cooling mode, the controller 900 operates the peltier element 800 so as to start a cooling mode of the peltier element 800 and to operate all the elements associated with the peltier element 800.

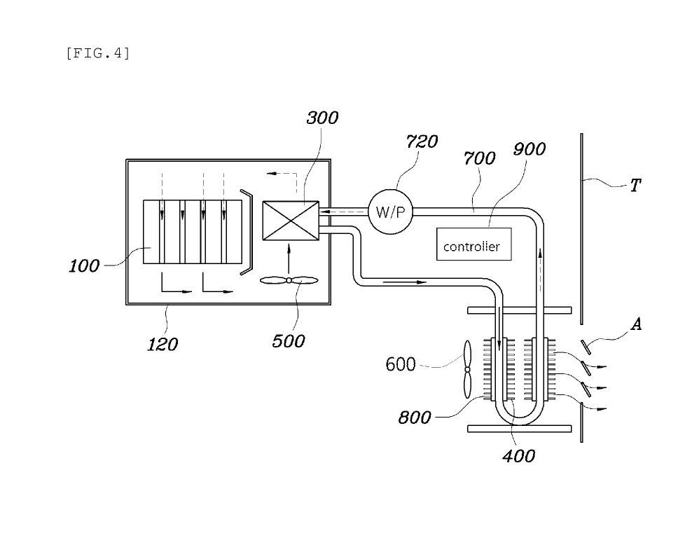

Further, referring to FIG. 4, when it is necessary to heat the high-voltage battery 100, the controller 900 may operate the peltier element 800 so as to emit the heat from the first surface of the peltier element 800 and may operate the first blower 500. That is, in a battery heating mode, the peltier element 800 generates heat from the first surface thereof. Accordingly, during the battery heating mode, the controller 900 operates the first blower 500 inside the battery housing 120, thereby performing the battery heating mode using the heat transferred to the first heat exchanger 300 through the cooling line 700. In the above state, the second blower 600 does not operate while the cooling line 700 is operated, and thus, heat is not dissipated from the peltier element 800.

The air conditioning method for the high-voltage battery of the vehicle using the above-mentioned air conditioning system includes selecting an operational mode required by the high-voltage battery. A high stage cooling of the system is operated when a high stage cooling mode has been selected, in which the controller 900 activates both the first blower 500 and the second blower 600, controls the peltier element 800 so as to cool the first surface of the peltier element 800, and circulates the coolant through the cooling line 700. In other words, to air-condition the high voltage battery of the vehicle, one of the low stage cooling mode, the high stage cooling mode, and the heating mode is selected. After the high stage cooling mode has been selected, both the first blower 500 and the second blower 600 are activated, the peltier element 800 cools the first surface of the peltier element 800, and the coolant is circulated through the cooling line 700.

Referring to FIG. 2, when the low stage cooling mode has been selected, the controller 900 performs a low stage cooling operation, in which the coolant is circulated through the cooling line 700, and the first blower 500 is activated.

When the heating mode has been selected, the controller 900 performs a heating operation, in which the peltier element 800 emits the heat from the first surface thereof, and both the first blower 500 and the cooling line 700 are activated, as shown in FIG. 4.

In the air conditioning system and method for the high-voltage battery of the vehicle according to the present disclosure, heat of the peltier element can be efficiently dissipated without using hot/cold air of a passenger compartment, thus efficiently air-conditioning the high-voltage battery.

In addition, the present disclosure directly dissipates waste heat of the peltier element to the atmosphere using a temperature difference between trunk room air and outside air, thus improving the operational performance of the air conditioning system for the high-voltage battery.

According to the present disclosure, an outside radiator is installed adjacent a conventional air extract hole that discharges passenger compartment air, thus exchanging the heat by naturally circulated air during a normal driving mode of the vehicle, thereby using minimal energy.

In addition, the present disclosure does not use cold passenger compartment air, thereby reducing the cooling load of the primary air conditioner of the vehicle which controls the passenger compartment air.

Although an exemplary embodiment of the present disclosure has been described for illustrative purposes, those skilled in the art will appreciate that various modifications, additions, and substitutions are possible, without departing from the scope and spirit of the disclosure as disclosed in the accompanying claims.

What is claimed is:

1. An air conditioning system for a high-voltage battery of a vehicle, the system comprising:
a first heat exchanger provided in a battery housing, and a first blower for supplying air to the first heat exchanger at a position adjacent to the first heat exchanger;
a second heat exchanger provided in an air extractor of a trunk room, and a second blower for supplying air to the second heat exchanger at a position adjacent to the second heat exchanger, thereby discharging air inside the trunk room to an outside after exchanging heat between the air inside the trunk room and the second heat exchanger;
a peltier element combined with the second heat exchanger in such a way that a first surface of the peltier element is in contact with the second heat exchanger;
a cooling line, through which a coolant circulates, is arranged in such a way that a first end thereof is in contact with a second surface of the peltier element and a second end thereof exchanges heat between the second end and the first heat exchanger.

2. The air conditioning system of claim 1, wherein the battery housing has a sealed structure, and the first heat exchanger and the first blower are disposed inside the battery housing so as to control air inside the battery housing, wherein the second end of the cooling line is inserted into the battery housing and combined with the first heat exchanger inside the battery housing.

3. The air conditioning system of claim 1, wherein the second heat exchanger is disposed inside the trunk room at a location adjacent to the air extractor, and the second blower is disposed at a back side of the second heat exchanger and blows the air inside the trunk room to the second heat exchanger.

4. The air conditioning system of claim 1, wherein the cooling line has a hydraulic pump so as to circulate a coolant through the cooling line.

5. The air conditioning system of claim 1, wherein the battery housing is installed in a front part inside the trunk room, and the air extractor is installed in a side part of the trunk room.

6. The air conditioning system of claim 1, wherein each of the first heat exchanger and the second heat exchanger has a plurality of heat dissipating fins, thus exchanging heat between the fins and air.

7. The air conditioning system of claim 1, further comprising:
a controller for controlling operation of the first blower, the second blower, the peltier element, and the cooling line.

8. The air conditioning system of claim 7, wherein, when the high-voltage battery needs to be cooled using a low stage cooling mode, the controller operates the cooling line and the first blower.

9. The air conditioning system of claim 7, wherein, when the high-voltage battery needs to be cooled using a high stage cooling mode, the controller operates the first blower, the second blower, the peltier element, and the cooling line.

10. The air conditioning system of claim 7, wherein, when the high-voltage battery needs to be heated, the peltier element emits heat from the first surface of the peltier element, and the cooling line and the first blower are operated by the controller.

11. An air conditioning method for a high-voltage battery of a vehicle, the method being performed using the air conditioning system of claim 7, the method comprising:
selecting an operational mode required by the high-voltage battery; and
performing a high stage cooling operation when a high stage cooling mode has been selected, in which both the first blower and the second blower are activated, the peltier element cools the first surface of the peltier element, and the coolant is circulated through the cooling line.

12. The air conditioning method of claim 11, further comprising:
performing a low stage cooling operation, in which the coolant is circulated through the cooling line and the first blower is activated, when a low stage cooling mode has been selected in the selecting the operational mode.

13. The air conditioning method of claim 11, further comprising:
performing a heating operation, in which the peltier element emits heat from the first surface of the peltier element, and the first blower and the cooling line are activated, when a heating mode has been selected in the selecting the operational mode.
